(19) United States
(12) Patent Application Publication
(10) Pub. No.: US 2026/0067253 A1
(43) Pub. Date: Mar. 5, 2026

(54) VPN CLIENT CREATION IN A SINGLE STACK IPv6

(71) Applicant: Ivanti, Inc., South Jordan, UT (US)

(72) Inventors: Chikurambotla Santhosh, Bengaluru (IN); Abhishek Dwivedi, Bengaluru (IN); Vagish Kalligudd, Bengaluru (IN)

(73) Assignee: Ivanti, Inc., South Jordan, UT (US)

(21) Appl. No.: 19/296,354

(22) Filed: Aug. 11, 2025

(30) Foreign Application Priority Data
Aug. 27, 2024 (IN) 202411064646

(51) Int. Cl. H04L 9/40

(52) U.S. Cl. CPC H04L 63/0272; H04L 63/0236; H04L 63/029

(57) ABSTRACT

A method includes creating a virtual adapter at an endpoint that is configured for split tunneling of data traffic via a virtual private network (VPN) connection with an internet protocol version 6 (IPv6) only internal network. The method includes assigning only an IPv6 address to the virtual adapter, such that it does not have an internet protocol version 4 (IPv4) address or an automatic private IP address (APIPA) IPv4 address. The method includes blocking domain name server (DNS) traffic when a source internet protocol (IP) address of the DNS traffic being a physical adapter IP address of a physical adapter. The method includes accessing excluded resources configured for IPv4 and IPv6 split tunneling policies via the physical adapter, forcing access to excluded IPv4 only resources via the physical adapter in DNS64/NAT64 environments, and forcing applications that prefer IPv4 over IPv6 to use IPv6 while accessing dual stack resources.

### CROSS-REFERENCE TO RELATED APPLICATION

This application claims the benefit of and priority to Indian Provisional Application No. 202411064646, filed Aug. 27, 2024, the disclosure of which is incorporated herein by reference in its entirety.

### FIELD

The present disclosure relates to secured data communication and resource access. In particular, the present disclosure relates to creation of a virtual private network (VPN) client in a single stack internet protocol version 6 (IPv6) and network data traffic management.

### BACKGROUND

The transition of managed networks from internet protocol version 4 (IPv4)-only or dual stack networks to interment protocol version IPv6-only (single stack IPv6) networks is problematic. The transition imposes additional requirements on VPN clients and adds complexity to management of split tunneling and to domain name server (DNS) resolution. Accordingly, there is a need in the field of VPNs and secured data communication to provide techniques that overcome the above-mentioned problems.

The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of an embodiment includes a method of data traffic management in networks having mixed internet protocol (IP) address standards. The method may include creating a virtual adapter at an endpoint. The virtual adapter is configured for split tunneling of at least a portion of data traffic via a virtual private network (VPN) connection with an internet protocol version 6 (IPv6) only internal network including at least one internal resource. The endpoint is communicatively connected to at least one external resource. The method may include assigning only an IPv6 address to the virtual adapter, such that the virtual adapter does not have an internet protocol version 4 (IPv4) address or an automatic private IP address (APIPA) IPv4 address. The method may include blocking domain name server (DNS) traffic in response to a source internet protocol (IP) address of the DNS traffic is a physical adapter IP address of a physical adapter. The method may include accessing excluded resources configured via IPv4 and IPv6 split tunneling policies via the physical adapter. The method may include forcing access to excluded IPv4 only resources via the physical adapter in DNS64/NAT64 environments. The method may include forcing applications that prefer IPv4 over IPv6 to use IPv6 while accessing dual stack resources.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment in which some embodiments of the present disclosure may be implemented;

FIG. 2A depicts a generation process of a virtual adapter at an endpoint that may be implemented in the operating environment of FIG. 1;

FIG. 2B is a block diagram of an example routing process that may be implemented by the client;

FIG. 2C is a block diagram of an example forced access process that may be implemented by the client;

FIG. 2D is a block diagram of an example traffic blocking process that may be implemented by the client;

FIG. 2E is a block diagram of an access process that may be implemented by the client;

FIG. 3 depicts a first fully qualified domain name (FQDN) table;

FIG. 4 depicts a first configuration table;

FIG. 5 depicts a first behavior table;

FIG. 6 depicts a second FQDN table;

FIG. 7 depicts a second configuration table;

FIG. 8 depicts a second behavior table;

FIG. 9 depicts a third FQDN table;

FIG. 10 depicts a third configuration table;

FIG. 11 depicts a third behavior table;

FIG. 12 illustrates an example computer system configured for data traffic management in networks having mixed IP address standards;

FIG. 13 is a block diagram of an example method of data traffic management in networks having mixed internet protocol (IP) address standards;

FIG. 14 is a block diagram of an example method of blocking traffic based on source IP address;

FIG. 15 is a block diagram of an example method of accessing the excluded resources configured for IPv4 and IPv6 split tunneling policies; and

FIG. 16 is a block diagram of an example method of forcing access to excluded IPv4-only resources via the physical adapter in DNS64/NAT64 environments,

all according to at least one embodiment described in the present disclosure.

### DESCRIPTION OF SOME EXAMPLE EMBODIMENTS

The present disclosure relates to secured data communication and internal resource access in managed networks. Some embodiments of the present disclosure are applicable during a transition period from internet protocol version 4 (IPv4) to internet protocol version 4 (IPv6). For instance, when an organization migrates to an IPv6 only (single stack IPv6) environment, the administrators might configure IPv6-only tunnel configurations, such as IPv6 only virtual adapter IP address and split tunneling rules that include IPv4 and IPv6 excluded addresses on the virtual private network (VPN) servers. Some embodiments describe VPN clients and techniques utilized by the VPN clients to enable the transition to IPv6.

For example, some embodiments include methods and systems for creating a VPN client in a single stack IPv6 and techniques for creating a VPN client based on a single stack IPv6 only virtual adapter. The VPN client is implemented in managed networks that support single stack IPv6 tunnels and are capable of handling various network configurations at the endpoints. In these embodiments, the VPN client ensures that traffic (e.g., data traffic) through the virtual adapter is IPv6-only.

Additionally, some embodiments enable enforcement of IPv4/IPv6 split tunneling rules, which may be configured by an administrator of the managed network. For instance, on IPv4-only endpoints, if an excluded resource with both IPv4 and IPv6 addresses is accessed within a single stack IPv6 environment, then the VPN client ensures that the excluded resource is accessed correctly via a IPv4 network of the endpoints, rather than through the tunnel's IPv6 network. This approach prevents or substantially reduces a VPN server from being burdened with handling excluded traffic. Additionally, these embodiments ensure that excluded traffic is accessed via a physical adapter and enables support of environments in which DNS64/Network Address Translation (NAT)64 is configured. Furthermore, based on the administrator's configuration, the VPN client ensures that domain name server (DNS) resolution occurs through internal IPv6 DNS servers, which may prevent or reduce DNS queries from being resolved through DNS servers of the endpoints.

Additionally, some embodiments address applications that prioritize IPv4 over IPv6. For instance, Java™ prioritizes IPv4 over IPv6 in at least some circumstances. These embodiments enable the applications to access internal resources via the single stack IPv6 internal network even when interacting with dual stack resources.

To further clarify the advantages and features of the present invention, a more particular description of the invention will be rendered by reference to specific embodiments thereof, which are illustrated in the appended drawings. It is appreciated that these drawings depict some example embodiments of the invention and are therefore not to be considered limiting of its scope. The invention will be described and explained with additional specificity and detail with the accompanying drawings. Further, skilled artisans will appreciate that elements in the drawings are illustrated for simplicity and may not have been necessarily drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

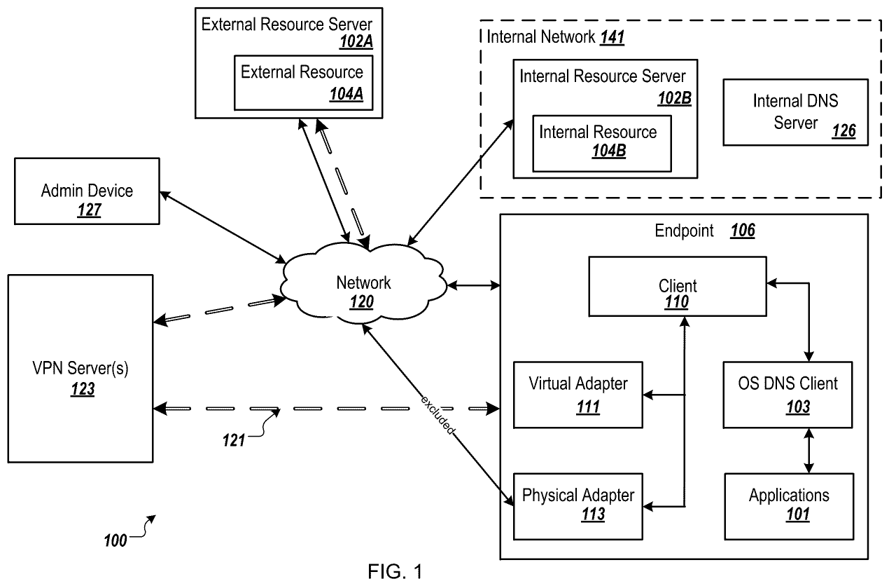

FIG. 1 is a block diagram of an example operating environment 100 in which some embodiments of the present disclosure may be implemented. In the operating environment 100, an endpoint 106 is configured to communicate data and information with an internal domain name system (DNS) server 126, virtual private network (VPN) servers, and resource servers 102A and 102B. Some of the data and information communicated in the operating environment 100 (hereinafter, data traffic) is routed via a VPN tunnel 121. For instance, sensitive or confidential data traffic may be routed through the VPN tunnel 121 (in FIG. 1, the VPN tunnel is represented by a thick dashed line). The VPN tunnel 121 is a secure, encrypted pathway between an internal network 141 and the VPN servers 123 and/or between the endpoint 106 and the VPN servers 123. Other data traffic may be excluded from the VPN tunnel 121 and instead communicated via a public, unencrypted network (e.g., a network 120). The excluded data traffic is communicated via a physical adapter 113 of the endpoint 106 and the tunnelled data traffic is communicated via the virtual adapter 111. The client 110 controls the virtual adapter 111 and designates data traffic as either excluded or tunnelled as described elsewhere in the present disclosure.

In addition, the operating environment 100 includes the internal network 141. In the example of FIG. 1, the internal network 141 or components thereof (e.g., 102B and 126) are configured for communication via internet protocol version 6 (IPv6). For instance, the internal network 123 may be IPv6-only or includes a majority of components configured for IPv6 communications. However, the endpoint 106 may or may not be configured for IPv6 communications. For instance, the endpoint 106 may be configured for IPv4-only communication, IPv6-only communication, or dual stack communications (e.g., some combination of IPv4 and IPv6). The client 110 is implemented in the endpoint to address to support single stack IPv6 tunnels (e.g., the VPN 121) using the virtual adapter and to manage the virtual adapter 111 and physical adapter 113 to ensure the tunnelled data traffic through the virtual adapter 111 is IPv6 only. For instance, the client 110 may be configured to enforce IPv4/IPv6 split tunneling rules, to enforce access rules for excluded resources, to supports DNS64/NAT64 environments, to manage DNS resolution through the internal IPv6 DNS server 126, to implement similar VPN-management operations, or some combination thereof.

The client 110 and operations it implements addresses the technical problem of VPN-based communication in IPv6-only networks such as the internal network 141. For instance, the client 110 improves data traffic management as endpoint (e.g., 106) and internal networks 141 transition to IPv6 from IPv4. The operations implemented by the client 110 may ensure IPv6 data traffic is accessed with in single stack IPv6 environment, reduce computing and bandwidth burdens on the VPN servers 123 by excluding data traffic with large data loads, and reduce or prevent DNS queries from being resolved through DNS servers outside the internal network 141.

The operating environment 100 includes the endpoint 106, the internal network 141, the VPN servers 123, the admin device 127, and the resource servers 102A and 102B, (collectively, “environmental components”). The environmental components are configured to communicate data and information such as DNS requests, DNS responses, data traffic, etc. via the network 120 and, depending on configurations, via the VPN tunnel 121. Each of the environmental components are introduced in the following paragraphs.

The network 120 may be comprised of many interconnected computer systems and communication links. The communication links may be hardware links, optical links, satellite or other wireless communications links, wave propagation links, or any other mechanisms for communication of information. Various communication protocols may be used to facilitate communication between the systems of FIG. 1. These communication protocols may include TCP/IP, HTTP protocols, wireless application protocol (WAP), vendor-specific protocols, customized protocols, and others. In one embodiment, the network 120 is at least partially comprised of the Internet, or another communication network including a local area network (LAN), a wide area network (WAN), a wireless network, an intranet, a private network, a public network, a switched network, and combinations of these, and the like.

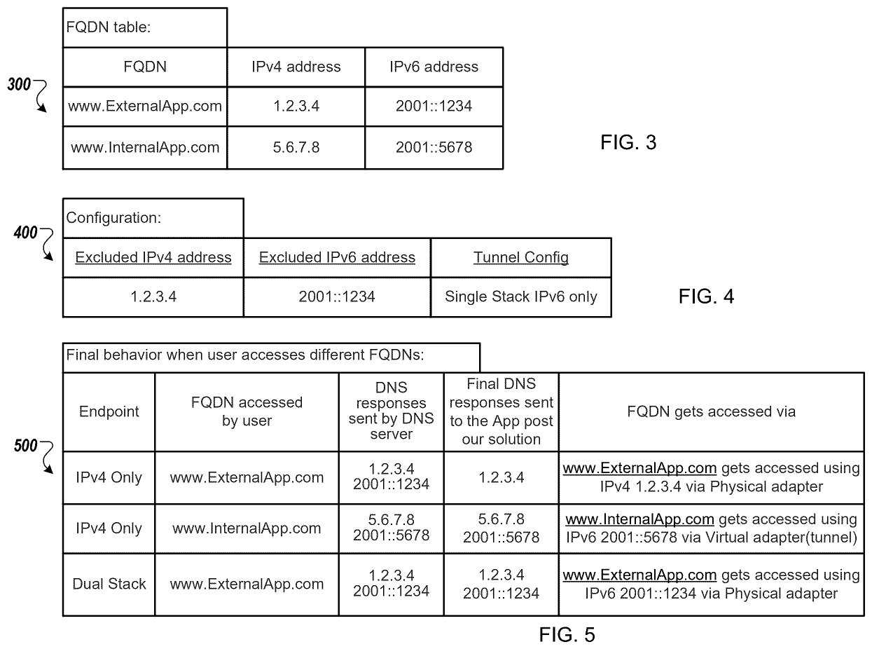

The admin device 127 includes a hardware-based computing device that is configured to communicate with the other environment components via the network 120. The admin device 127 is configured to communicate rules that dictate operations of the client 110. For instance, the admin device 127 may be operated by an administrator that determines which data traffic is excluded and which is tunnelled. The administrator uses the admin device 127 to communicate instructions to the endpoint 106, which are used by the client 110. The instructions may include fully qualified domain name (FQDN) tables and configurations, which may be communicated from the admin device 127 to the endpoint 106. Some examples of the rules and instructions are provided in a table format in FIGS. 3, 4, 6, 7, 9 and 10. Although the admin device 127 of FIG. 1 is outside the internal network 141. In some embodiments, the admin device 127 may be included in the internal network 141.

The VPN servers 123 include a hardware-based computing device that is configured as intermediary between the endpoint 106 and the resource servers 102A and 102B. The VPN servers 123 are configured to create a secure, encrypted tunnel (e.g., the VPN tunnel 121) for data traffic communicated in the operating environment 100. The tunneled data traffic is communicated via the VPN tunnel 121 where it is more secure than the data traffic excluded from the VPN tunnel 121.

The operating environment 100 includes an internal resource server 102B and an internal DNS server 126. The internal resource server 102B and the internal resource server 102B include hardware-based computing devices configured to communicate with other environment components via the network 120 and/or the VPN tunnel 121.

The internal resource server 102B hosts an internal resource 104B. The internal resource 104B is a secured or a sensitive computing resource such as a database or enterprise application. The endpoint 106 may access the internal resources 104B on the internal resource server 102B via the VPN tunnel 121. For instance, the internal resource 104B may include an enterprise email application. The endpoint 106 may access the enterprise email application on the internal resource server 102B via the VPN tunnel 121.

The internal DNS server 126 acts as a translator between human-readable website names and numerical IP addresses that are used to locate the website. Accordingly, the internal DNS server 126 may receive DNS requests and communicate DNS responses. The DNS requests are configured to locate an IP address of a website and the DNS responses include the requested IP address along with other information related to the website. For instance, an operating system (OS) DNS client 103 of the endpoint 106 receive a request to access a particular website an application 101. The OS DNS client 103 may communicate a DNS request to the internal DNS server 126 which requests the IP address of the particular website. The internal DNS server 126 communicates a DNS response that includes an IP address of the particular website. The client 110 receives the DNS response and determines whether data traffic with the particular website is routed via a public network (e.g., the network 120) or via the VPN tunnel 121. The particular website may be the internal resource server 102B, which may enable access to the internal resource 104B. Accordingly, the DNS response may include the IP address of the internal resources 104B.

In the depicted embodiment, the internal resource server 102B may be an IPv6 only device. Accordingly, the client 110 directs communications between the endpoint 106 and the internal resource server 102B.

The internal DNS server 126 and the internal DNS server 126 are included in the internal network 141. The internal network 141 is a controlled and private portion of the operating environment 100. The internal network 141 may be owned and controlled by an organization such as a business or governmental entity. Access to components (e.g., 102B and 126) of the internal network 141 is controlled. For instance, access to the components may be limited or restricted to endpoints (e.g., 106) associated with particular users, associated with the organization, configured according to a policy, meeting particular security criteria, using a particular network interface, or some combination thereof. A part of access restriction to the internal resource 104B may include communication via the VPN tunnel 121. For instance, the client 110 may be configured to route data traffic between the internal resource server 102B and the endpoint 106 via the VPN servers 123 to reduce vulnerability of the data traffic.

The external resource server 102A includes a hardware-based computing device that is configured to communicate with other environment components via the network 120 or via the VPN tunnel 121. In the embodiment of FIG. 1, the external resource server 102A is located outside the internal network 141. Accordingly, at least a portion of the external resource server 102A may not be controlled as part of a private network. The external resource server 102A hosts an external resource 104A. One or more application 101 on the endpoint 106 may access the external resource 104 at the external resource server 102A. In some instances, the external resource 104A may be accessed via a public network including at least a portion of the network 120. In other instances, the external resource 104A may be accessed via the VPN tunnel 121. For instance, the external resource server 102A may include a public video website and the external resource 104A may include video file hosted on the external resource server 102A. The application 101 may include a video player or web browser that accesses and plays the video file. In this example, the video file may be accessed via the public network. Accordingly, the request for and access to the video file may be managed by the client 110 and the physical adapter 113. Alternatively, the external resource server 102A may include a banking institution. In some embodiments, the data traffic between the external resource server 102A and the endpoint 106 may be routed via the VPN tunnel 121.

The endpoint 106 includes a hardware-based computer system that is configured to communicate with the other components of the operating environment 100 via the network 120. The endpoint 106 includes a device that is operated by the personnel and systems of an enterprise or store data of the enterprise. The endpoint 106 might include workstations of an enterprise, servers, data storage systems, printers, telephones, internet of things (IOT) devices, smart phones, smart watches, sensors, automobiles, etc. The endpoints 106 may also include virtual machines, which may include a portion of a single processing unit or one or more portions of multiple processing units, which may be included in multiple machines. The endpoint 106 may have a IPv4-only configuration, a IPv6-only configuration, or a dual stack network configuration.

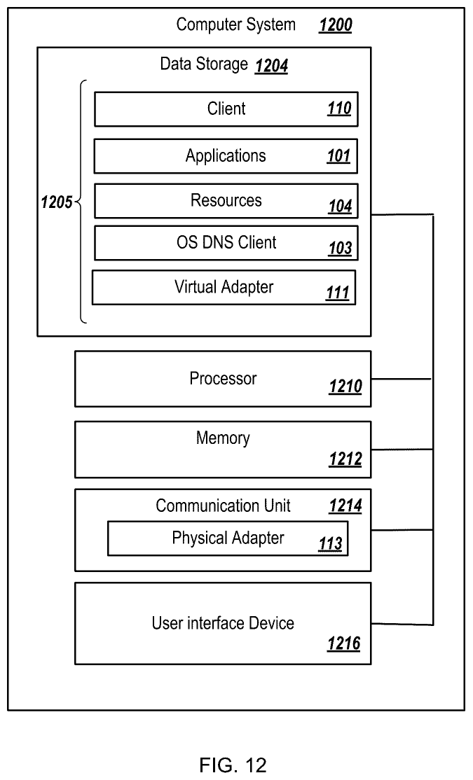

The endpoint 106 includes the physical adapter 113, the virtual adapter 111, the client 110, the OS DNS client 103, and the application 101. The physical adapter 113 is a hardware-based component that connects the endpoint 106 to the network 120 to enable data and information to be communicated to the environment components. Some examples of the physical adapter 113 are provided with reference to the communication unit 1214 described with reference to FIG. 12. In FIG. 1, the client 110 routes excluded or non-tunnelled data traffic via the physical adapter 113. A portion of the excluded data traffic communicated via the physical adapter 113 includes IPv4 data traffic.

The virtual adapter 111 operates similarly to the physical adapter 113. However, the virtual adapter 111 does not include dedicated hardware. Functionality of the virtual adapter 111 is implemented as non-transitory computer readable instructions implemented one or more non-dedicated hardware devices. The client 110 configures and manages the virtual adapter 111 based on DNS response data and FQDN and configuration information. Also, the client 110 assigns an IPv6 address to the virtual adapter 111. Accordingly, in these and other embodiments, the virtual adapter 111 does not have an IPv4 address or an automatic private IP address (APIPA) IPv4 address.

The application 101 may include software applications of any kind or type. Some examples of the application 101 may include a software application, a web browser application, an enterprise software, an operating system, and the like. The application 101 is configured to access fully qualified domain names (FQDNs) in some embodiments, which may include external resource server 102A and internal resource server 102B (generally, resource server 102 or resource servers 102).

To access the external resource 104A or the internal resources 104B (generally, resource 104 or resources 104) at the resource server 102, the application 101 may initiate a DNS request, which may be generated by the OS DNS client 103. The OS DNS client 103 may communicate the DNS request to the internal DNS server 126 obtain an IP address of the resource 104 or the resource server 102.

The internal DNS server 126 resolves the DNS request. In response, the internal DNS server 126 communicates a DNS response to the endpoint 106. The client 110 uses the DNS response (along with FQDN and configuration information described below) to determine whether communications with the resource server 102 occur via the VPN tunnel 121 or a public network (e.g., outside the VPN tunnel 121). More particularly, the client 110 uses the DNS response to determine whether data traffic between the resource server 102 and the application 101 is routed via the virtual adapter 111 or via the physical adapter 113.

In addition to the DNS responses, the client 110 may receive FQDN and configuration information such as the FQDN and configuration tables of FIGS. 3, 4, 6, 7, 9, and 10 from the admin device 127. The client 110 determines whether data traffic is excluded or tunneled based on the DNS responses and/or directives included in the FQDN and configuration information. In some embodiments, the OS DNS client 103 may be a platform-specific DNS client. In these and other embodiments, the OS DNS client 103 may be responsible for the DNS resolution of FQDNs such as the resources 104 or the resource servers 102.

In the embodiment of FIG. 1, the client 110 is configured to ensure data traffic communicated via the virtual adapter 111 is IPv6 traffic. Additionally, the client 110 is configured to ensure data traffic communicated via the virtual adapter 111 (e.g., tunnelled data traffic) does not include IPv4 traffic. The client 110 is further configured to ensure the endpoint 106 only uses a single stack IPv6 tunnel to access the resources 104 and blocks DNS resolution via the physical adapter 113.

More generally, the client 110 is configured for data traffic management in the operating environment 100 having mixed IP address standards. For instance, the endpoint 106 may operate according to the IPv4 standard (or may have a dual stack network configuration) and the internal network 141 may operate according to the IPv6 standard. The client 110 is configured for split tunneling of data traffic via the VPN tunnel 121 with the IPv6-only internal network 141. For example, the client 110 may block certain DNS traffic based on a source IP address, may force access to certain resources via the physical adapter 113 in DNS64/NAT64 environments, and may force use of IPv6 while accessing dual stack resources when the application 101 prefers IPv4 over IPv6, as described elsewhere in the present disclosure.

The client 110, the virtual adapter 111, and components thereof may be implemented using hardware including a processor, a microprocessor (e.g., to perform or control performance of one or more operations), a field-programmable gate array (FPGA), or an application-specific integrated circuit (ASIC). In some other instances, the client 110, the virtual adapter 111, and components thereof may be implemented using a combination of hardware and software. Implementation in software may include rapid activation and deactivation of one or more transistors or transistor elements such as may be included in hardware of a computing system (e.g., the endpoint 106). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more internal networks 141, one or more resource servers 102, one or more endpoints 106, one or more VPN servers 123, one or more admin devices 127 or any combination thereof. Moreover, the separation of various components and devices in the examples described herein is not meant to indicate that the separation occurs in all examples. Moreover, it may be understood with the benefit of this disclosure that the described components and servers may generally be integrated together into a single component or server or separated into multiple components or servers.

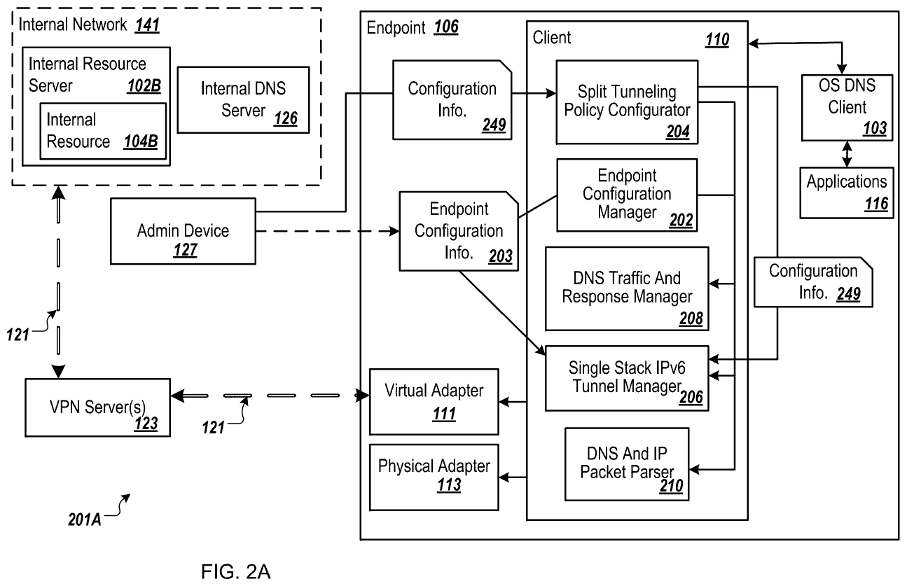

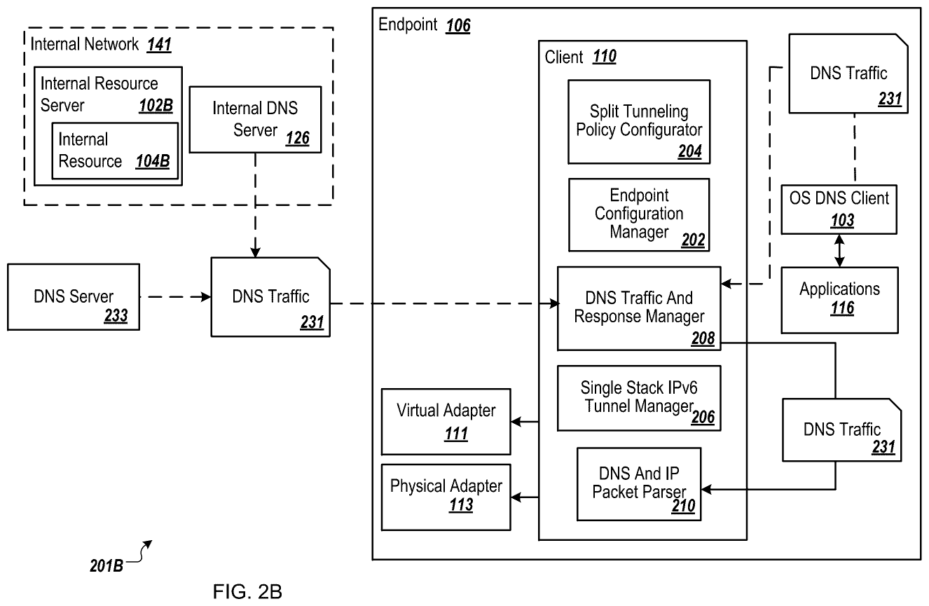

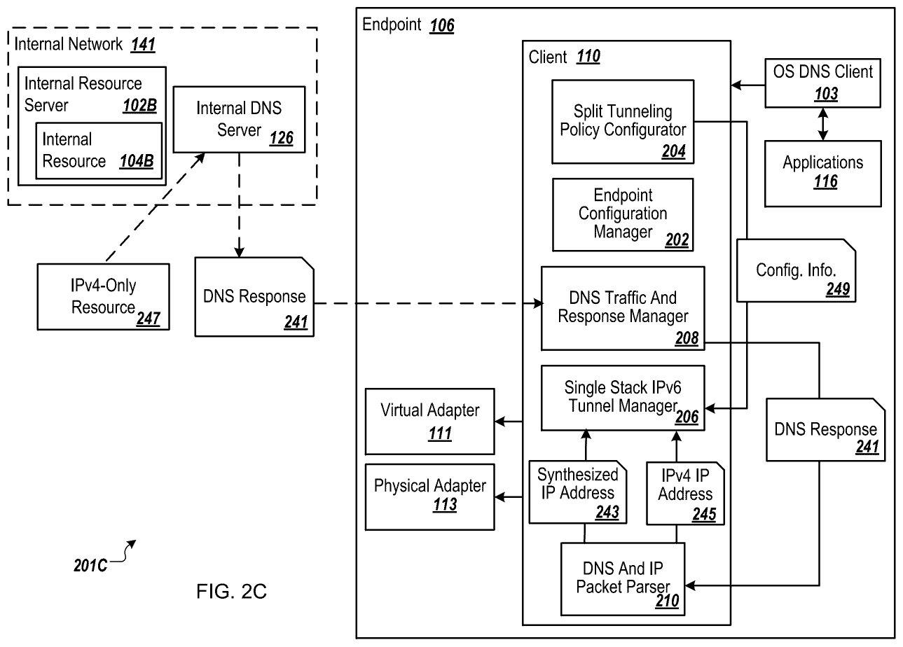

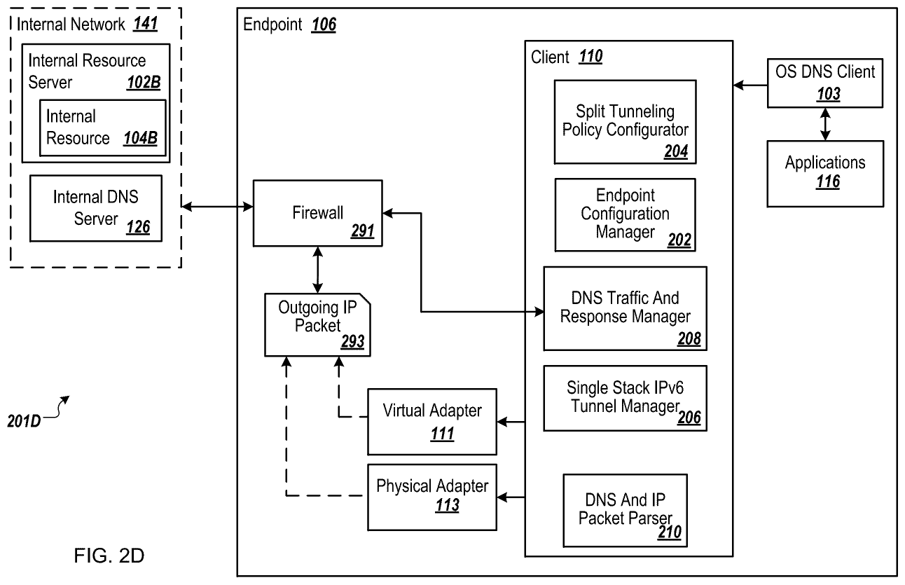

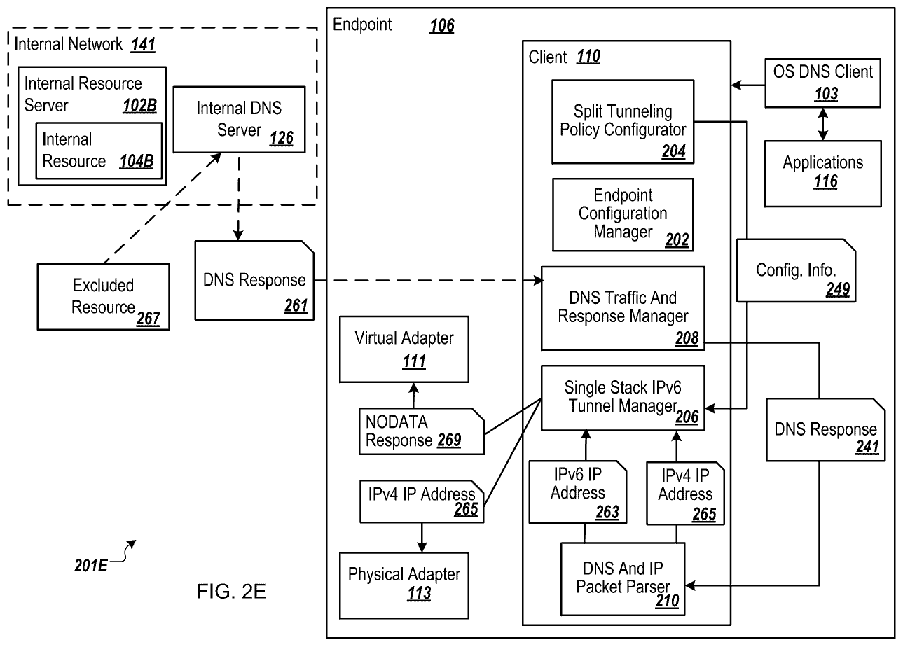

FIGS. 2A-2E are block diagrams of an example of the client 110 of the endpoint 106 of FIG. 1. The client 110 is described with the virtual adapter 111, the physical adapter 113, the OS DNS client 103, and the applications 116 introduced with reference to FIG. 1. FIGS. 2A-2E depict processes 201A-201E that may be performed by the client 110. For example, FIG. 2A depicts an example generation process 201A of the virtual adapter 111 at the endpoint 106, FIG. 2B depicts an example routing process 201B, FIG. 2C depicts an example forced access process 201C, FIG. 2D depicts an example traffic blocking process 201D, and FIG. 2E depicts an example access process 201E.

With reference to FIGS. 2A-2E, the client 110 may include a split tunneling policy configurator 204, an endpoint configuration manager 202, a DNS traffic and response manager 208, a single stack IPv6 tunnel manager 206, and a DNS and IP packet parser 210. Each of which is introduced below. The endpoint configuration manager 202 identifies a configuration of the endpoint 106. The endpoint 106 may include an IPv4 only configuration, an IPv6 only configuration, or a dual stack configuration, for instance. Endpoint configuration information 203 may be used by the client 110 in one or more of the processes (201A-201E) described in the present disclosure.

The split tunneling policies configurator 204 receives and maintains the split tunneling configuration information sent from VPN servers 123 or the admin device 127 of FIG. 1. For instance, the split tunneling policies configurator 204 may receive configuration information indicating or identifying exclude IPv4 addresses and excluded IPv6 addresses.

The DNS traffic and response manager 208 manages DNS traffic. For example, the DNS traffic and response manager 208 receives the DNS responses from the internal IPv6 DNS server (e.g., 126 of FIG. 1) that is behind the VPN servers 123. Based on the IPv4 or IPv6 address in the DNS response, the DNS traffic and response manager 208 decides whether to drop or pass through the particular DNS response packet. The DNS traffic and response manager 208 makes the determination based at least in part on the endpoint configuration information of the endpoint configuration manager 202 and the split tunneling configuration information of the split tunneling policies configurator 204. Additionally, the DNS traffic and response manager 208 may interface and direct operations of a firewall in some embodiments.

The single stack IPv6 tunnel manager 206 manages the virtual adapter 111 (which has only the IPv6 address) along with the data traffic sent and received from the virtual adapter 111. In these and other embodiments, the single stack IPv6 tunnel manager 206 may be configured to create the virtual adapter 111, configure the virtual adapter 111 with the IPv6 only configuration, update one or more route tables, handle the data traffic to and from the virtual adapter 111, or some combination thereof.

The DNS and IP packet parser 210 provides the parsing functionality of different layers of the network packet such as an IPv4 header, an IPv6 header, and DNS headers. The DNS and IP packet parser 210 is configured to parse DNS responses and DNS requests. Some details of parsing operations are provided with reference to the processes 201A-201E of FIGS. 2A-2E. A subset of the split tunneling policy configurator 204, the endpoint configuration manager 202, the DNS traffic and response manager 208, the single stack IPv6 tunnel manager 206, and the DNS and IP packet parser 210 are used in the processes 201A-201E of FIGS. 2A-2E.

FIG. 2A depicts a generation process 201A of the virtual adapter 111 at the endpoint 106. In the embodiment of FIG. 2A, the single stack IPv6 tunnel manager 206 is configured to create or generate the virtual adapter 111. The virtual adapter 111 is configured for split tunneling of at least a portion of data traffic via the VPN tunnel 121 with the IPv6-only internal network 141 or another IPv6 only network. The virtual adapter 111 is a virtual network adapter implemented without a dedicated piece of hardware. Instead, the virtual adapter 111 is implemented at least partially in non-transitory computing instructions that dictate operation of one or more network interface components. The virtual adapter 111 operates similarly to the physical adapter 113.

The single stack IPv6 tunnel manager 206 may receive the endpoint configuration information 203 from the endpoint configuration manager 202. The endpoint configuration information 203 may include configuration details of the endpoint 106 including hardware and software (e.g., the applications 101) implemented and whether the endpoint has a IPv4-only configuration, a IPv6-only configuration, or a dual stack network configuration. The virtual adapter 111 may modify or change the virtual adapter 111 to align with the endpoint configuration information 203. The single stack IPv6 tunnel manager 206 may then assign an IP address to the virtual adapter 111. In some embodiments, only an IPv6 address is assigned to the virtual adapter 111. Accordingly, in these and other embodiments, the virtual adapter 111 does not have an IPv4 address or an automatic private IP address (APIPA) IPv4 address.

In some embodiments, at least a portion of the endpoint configuration information 203 may be received from the admin device 127. For instance, the admin device 127 may provide network information, roles information, user information, security information, etc. that may at least partially dictate an aspect of the virtual adapter 111.

In addition, FIG. 2A depicts communication of configuration information 249 to the client 110. The configuration information 249 may be communicated from the admin device 127 or may be generated locally at the endpoint 106. The configuration information 249 includes fully qualified domain name (FQDN) information related to specific resources (e.g., 104B) and network configuration information that indicates which IP addresses are excluded from the VPN tunnel 121 (sometime referred to herein as an excluded list). Some examples of configuration information 249 are provided in FIGS. 3, 4, 6, 7, 9 and 10. The configuration information 249 in FIGS. 3, 4, 6, 7, 9 and 10 relate to a subset of processes or methods implemented by the client 110 in various embodiments. The configuration information 249 is used by the single stack IPv6 tunnel manager 206 to manage data traffic between the virtual adapter 111 and the physical adapter 113.

FIG. 2B is a block diagram of an example routing process 201B that may be implemented by the client 110 of FIG. 1. The routing process 201B is implemented to ensure DNS resolution on the endpoint 106 occurs via the internal IPv6 DNS Server 126 instead of external DNS servers.

In the routing process 201B, DNS traffic 231 may be received by the DNS traffic and response manager 208. As shown in FIG. 2B by dashed arrows, the DNS traffic 231 may include DNS requests communicated by the OS DNS client 103 or DNS responses communicated from a DNS server or the internal DNS server 126. The DNS traffic and response manager 208 may communicate the DNS traffic 231 to the DNS and IP packet parser 210. The DNS and IP packet parser 210 parses the DNS traffic to determine whether a source IP address of DNS traffic 231 is a physical adapter IP address. For instance, the DNS and IP packet parser 210 determines whether the source IP address of the DNS traffic 231 is the physical adapter 113 of the endpoint 106 or a physical adapter of another component (e.g., an IPv4 resource, IPv4 server, etc.) that is external to the endpoint 106.

Response to the source IP address of the DNS traffic 231 being the physical adapter IP address, the DNS traffic and response manager 208 blocks the DNS traffic 231. Blocking the DNS traffic 231 prohibits resolution of the DNS traffic 231 via any DNS server other than the internal DNS server 126.

FIG. 2C is a block diagram of an example forced access process 201C that may be implemented by the client 110 of FIG. 1. The forced access process 201C may be applied to excluded IPv4-only resources in DNS64/NAT64 environments. In the forced access process 201C, a DNS response 241 is received from an IPv4-only resource 247. For instance, the DNS traffic and response manager 208 may receive the DNS response 241. The DNS traffic and response manager 208 communicates the DNS response 241 to the DNS and IP packet parser 210.

The DNS and IP packet parser 210 parses the received DNS response 241 to determine whether the DNS response 241 includes a synthesized IPv6 address 243 generated in an DNS64/NAT64 environment. The DNS and IP packet parser 210 extracts an original IPv4 address 245 from the synthesized IPv6 address 243 of the received DNS response 241. The original IPv4 address 245 of the IPv4 resource 247 may be extracted based on the synthesized IPv6 address 243 of the received DNS response 241. For instance, the original IPv4 address 245 may be extracted using the last thirty-two (32) bits of the one-hundred and twenty-eight (128)-bit synthesized IPv6 address 243 of the received DNS response 241. The split tunneling policy configurator 204 or the single stack IPv6 tunnel manager 206 determines whether the IPv4 only resource 247 is designated as excluded in an excluded list, which is included in configuration information 249. An example of an excluded list is provided in the configuration table of FIG. 10.

In response to the IPv4-only resource 247 designated as excluded, the DNS traffic and response manager 208 drops an AAAA record of the received DNS response 241 such that the excluded IPv4 resource traffic is accessed via the physical adapter 113. In response to the IPv4-only resource 247 not designated as excluded the DNS traffic and response manager 208 routes the synthesized IP address to the virtual adapter 111.

FIG. 2D is a block diagram of an example traffic blocking process 201D that may be implemented by the client 110 of FIG. 1. The traffic block process 201D may be implemented to block traffic based on source IP address. In the traffic block process 201D, an outgoing IP packet 293 are received. In the traffic blocking process 201D is received at a firewall 291. The firewall 291 in FIG. 2D is a software firewall on the endpoint 106. An example of the firewall 291 may include the Window™ Firewall or another suitable software firewall. The firewall 291 may be included in the operating system installed on the endpoint 106. Alternatively, the firewall 291 may be implemented at an interface between a public network 295 and the internal network 141.

The DNS traffic and response manager 208 verifies that a source IP address of the outgoing IP packet 293 matches a virtual adapter IP address associated with the virtual adapter 111. In response to the source IP address matching the virtual adapter IP address, the IP packet 293 are passed through the firewall 291. In response to the source IP address not matching the virtual adapter IP address of the virtual adapter 111, the DNS traffic and response manager 208 determines whether a TCP/UDP destination port of the IP packet 293 is port 53. In response to the TCP/UDP destination port being port 53, the DNS traffic and response manager 208 controls the 291 such that the IP packet 293 is dropped at the firewall 291. In response to the TCP/UDP destination port not being port 53, the outgoing IP packet 293 is passed through the firewall 291.

FIG. 2E is a block diagram of an access process 201E that may be implemented by the client 110 of FIG. 1. The access process 201E may be implemented to access the excluded resources configured for IPv4 and IPv6 split tunneling policies. The excluded resources may include a network-heavy traffic data in some implementations. Routing network-heavy traffic data traffic reserves bandwidth allocated for tunneled traffic data.

In the access process 201E, a DNS response 261 is received. For instance, the DNS traffic and response manager 208 may receive the DNS response 261. The DNS response 261 is communicated to the DNS and IP packet parser 210. The DNS and IP packet parser 210 parses the received DNS response 261 to identify a record type. The record type may indicate that a resource corresponding to the DNS response 261 includes both IPv4 and IPv6 addresses 265 and 263, respectively. For instance, the record type may include an AAAA (or quad A) record that is indicative of both IPv4 and IPv6 addresses 265 and 263. The IPv6 and the IPv4 addresses 265 and 263 may be included on the excluded address list, which may be included in the configuration information 249.

The DNS traffic and response manager 208 replaces the DNS response 261 identified with the AAAA record (hereinafter, identified DNS response) with a dummy NODATA AAAA DNS response. For instance, in response to the received DNS response having the AAAA record, the identified DNS response is replaced with the dummy NODATA AAAA DNS response.

The single stack IPv6 tunnel manager 206 injects the dummy NODATA AAAA DNS response to the virtual adapter 111. The injection of the dummy NODATA AAAA DNS response results in the client 110 having only an IPv4 address for the excluded resource. The single stack IPv6 tunnel manager 206 routes excluded IPv4 address via the physical adapter 113 and the excluded resources are accessed via the physical adapter 113.

FIG. 12 illustrates an example computer system 1200 configured for data traffic management in networks having mixed IP address standards according to at least one embodiment of the present disclosure. The computer system 1200 may be implemented in the operating environment 100 of FIG. 1, for instance. Examples of the computer system 1200 may include the endpoint 106, the internal resource server 102B, the internal DNS server 126, the external resource server 102A, the admin device 127, the VPN servers 123, the DNS server 233, or some combination thereof. The computer system 1200 may include one or more processors 1210, a memory 1212, a communication unit 1214, a user interface device 1216, and a data storage 1204 that includes one or more or a combination of client 110, the applications 101, the resources 104, the OS DNS client 103, and the virtual adapter 111 (collectively, modules 1205).

The processor 1210 may include any suitable special-purpose or general-purpose computer, computing entity, or processing device including various computer hardware or software modules and may be configured to execute instructions stored on any applicable computer-readable storage media. For example, the processor 1210 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 12, the processor 1210 may more generally include any number of processors configured to perform individually or collectively any number of operations described in the present disclosure. Additionally, one or more of the processors 1210 may be present on one or more different electronic devices or computing systems. In some embodiments, the processor 1210 may interpret and/or execute program instructions and/or process data stored in the memory 1212, the data storage 1204, or the memory 1212 and the data storage 1204. In some embodiments, the processor 1210 may fetch program instructions from the data storage 1204 and load the program instructions in the memory 1212. After the program instructions are loaded into the memory 1212, the processor 1210 may execute the program instructions.

The memory 1212 and the data storage 1204 may include computer-readable storage media for carrying or having computer-executable instructions or data structures stored thereon. Such computer-readable storage media may include any available media that may be accessed by a general-purpose or special-purpose computer, such as the processor 1210. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 1210 to perform a certain operation or group of operations.

The communication unit 1214 may include one or more pieces of hardware configured to receive and send communications. In some embodiments, the communication unit 1214 may include the physical adapter 113. In some embodiments, the communication unit 1214 may include one or more of an antenna, a wired port, and modulation/demodulation hardware, among other communication hardware devices. In particular, the communication unit 1214 may be configured to receive a communication from outside the computer system 1200 and to present the communication to the processor 1210 or to send a communication from the processor 1210 to another device or network (e.g., the network 120 of FIG. 1).

The user interface device 1216 may include one or more pieces of hardware configured to receive input from and/or provide output to a user. In some embodiments, the user interface device 1216 may include one or more of a speaker, a microphone, a display, a keyboard, a touch screen, and a holographic projection, among other hardware devices.

The modules 1205 may include program instructions stored in the data storage 1204. The processor 1210 may be configured to load the system modules into the memory 1212 and execute the system modules. Alternatively, the processor 1210 may execute the system modules line-by-line from the data storage 1204 without loading them into the memory 1212. When executing the system modules, the processor 1210 may be configured to perform one or more processes or operations described elsewhere in this disclosure.

Modifications, additions, or omissions may be made to the computer system 1200 without departing from the scope of the present disclosure. For example, in some embodiments, the computer system 1200 may not include the user interface device 1216. In some embodiments, the different components of the computer system 1200 may be physically separate and may be communicatively coupled via any suitable mechanism. For example, the data storage 1204 may be part of a storage device that is separate from a device, which includes the processor 1210, the memory 1212, and the communication unit 1214, that is communicatively coupled to the storage device. The embodiments described herein may include the use of a special-purpose or general-purpose computer including various computer hardware or software modules, as discussed in greater detail below.

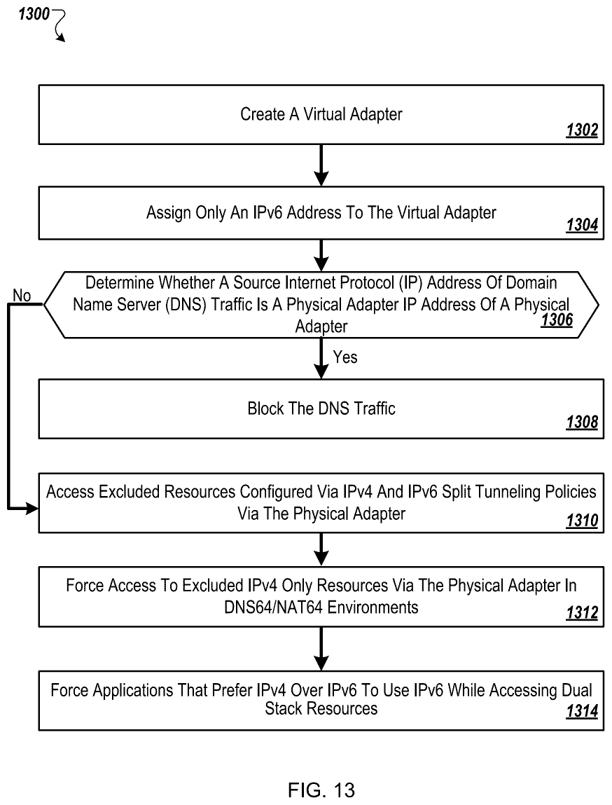

FIG. 13 is a block diagram of an example method 1300 of data traffic management in networks having mixed internet protocol (IP) address standards. The method 1300 may begin at block 1302 in which, a virtual adapter is created. The virtual adapter is created at an endpoint. The virtual adapter is configured for split tunneling of at least a portion of data traffic via a VPN connection with an IPv6-only internal network. The internal network includes at least one internal resource. Additionally, the endpoint is communicatively connected to at least one external resource, which may be hosted on an external server or external source. The virtual adapter may be a virtual network adapter implemented without hardware. Additionally, the endpoint includes a physical adapter, and the virtual adapter operates like the physical adapter. The endpoint may have a IPv4-only configuration, a IPv6-only configuration, or a dual stack network configuration.

At block 1304, an IP address is assigned to the virtual adapter. In some embodiments, only an IPv6 address is assigned to the virtual adapter. Accordingly, in these and other embodiments, the virtual adapter does not have an IPv4 address or an automatic private IP address (APIPA) IPv4 address.

At block 1306, it may be determined whether a source IP address of DNS traffic is a physical adapter IP address of the physical adapter. In response to the source IP address of the DNS traffic being the physical adapter IP address (“YES” at block 1306), the method 1300 may proceed to block 1308. In response to the source IP address of the DNS traffic not being the physical adapter IP address (“NO” at block 1306), the method 1300 may proceed to block 1310. At block 1308, the DNS traffic is blocked.

At block 1310, excluded resources configured via IPv4 and IPv6 split tunneling policies are accessed via the physical adapter. At block 1312, access to excluded IPv4 only resources may be forced via the physical adapter in DNS64/NAT64 environments. At block 1314, applications that prefer IPv4 over IPv6 are forced to use IPv6 while accessing dual stack resources. For example, in some embodiments, the forcing applications that prefer IPv4 over IPv6 to use IPv6 may include receiving a DNS response including both IPv4 over IPv6 from one resource; and filtering the DNS response including the IPv4 address such that only the IPv6 DNS response is received at the virtual adapter.

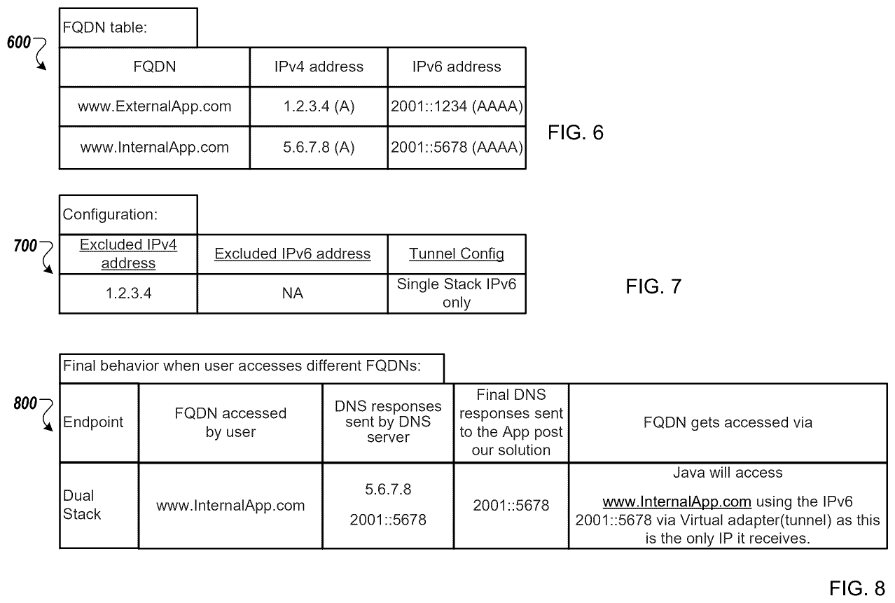

For example, FIGS. 6-8 depict a FQDN table 600, a configuration table 700, and a behavior table 800. FIGS. 6-8 are related to JAVA™, which is an example application that prefers IPv4 IP addresses. However, the virtual adapter is IPv6. Tables 600, 700, and 800 depict results of operations that force JAVA to utilize IPv6. For instance, in the FQDN table 600 two FQDNs are displayed along with an IPv4 address and an IPv6 address for each of the FQDNs. The IPv4 include an (A) designation following the IPv4 address indicates that the DNS response includes an A record that is a fundamental type that maps a domain name to an IPv4 address. The IPv6 include an (AAAA) designation following the IPv6 address that indicates that the DNS response includes an AAAA record used to map a domain name to an IPv6 address.

The configuration table 700 of FIG. 7 is related to the example FQDN table 600 of FIG. 6. The configuration table 700 designates the IPv4 address of 1.2.3.4 as an “excluded” address. It further designates the tunnel configuration as a single stack IPv6 only.

The behavior table 800 of FIG. 8 indicates where (e.g., the virtual adapter or the physical adapter) the example FQDN are accessed. In the behavior table 800, the DNS responses sent by the DNS server includes the IPv4 address and the IPv6 address. The IPv4 address is filtered and the IPv6 is sent to the application (e.g., JAVA). Accordingly, JAVA will access the www.internalapp.com FQDN using the IPv6 via the virtual adapter because only the IPv6 address is received after the IPv4 IP address is filtered.

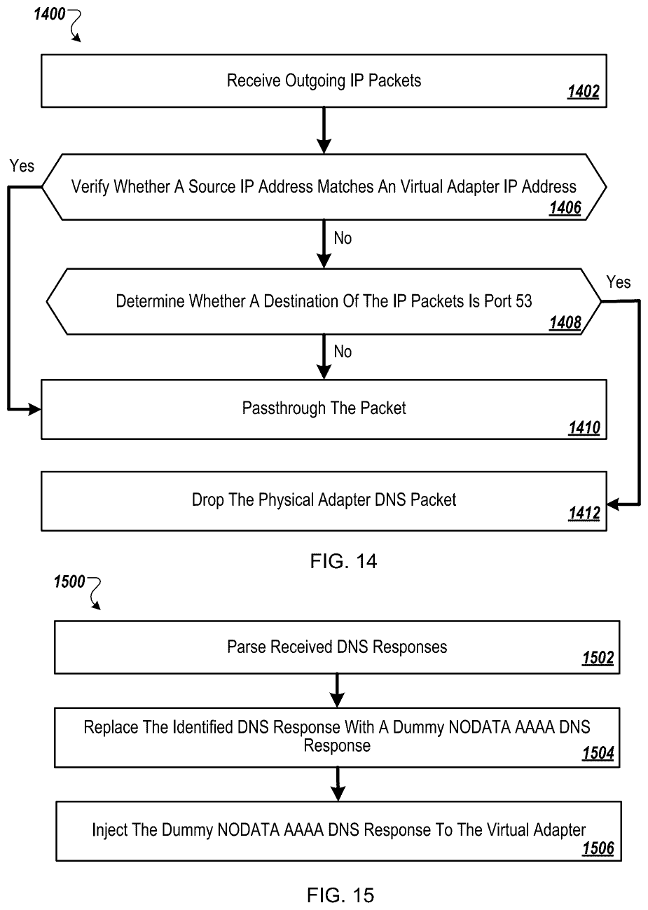

FIG. 14 is a block diagram of an example method 1400 of blocking traffic based on source IP address according to at least some embodiments of the present disclosure. The method 1400 may be implemented as part of another method such as block 1308 of the method 1300.

The method 1400 may begin at block 1402 in which outgoing IP packet(s) are received. The outgoing IP packets may be received at a firewall. At block 1406, it may be verified that a source IP address of the IP packet matches a virtual adapter IP address associated with the virtual adapter. In response to the source IP address matching the virtual adapter IP address (“YES” at block 1406), the method 1400 may proceed to block 1410. In response to the source IP address not matching the virtual adapter IP address (“NO” at block 1406), the method 1400 may proceed to block 1408. At block 1410, the IP packet(s) are passed through the firewall.

At block 1408, it may be determined whether a destination port of the IP packet is port 53. In response to the destination port being port 53 (“YES” at block 1408), the method 1400 may proceed to block 1412. In response to the destination port not being port 53 (“NO” at block 1408), the method 1400 may proceed to block 1410. At block 1412, the IP packet is dropped at the firewall. At block 1410, the IP packet may be passed through the firewall.

FIG. 15 is a block diagram of an example method 1500 of accessing the excluded resources configured for IPv4 and IPv6 split tunneling policies according to at least one embodiment of the present disclosure. In some embodiments, the excluded resources may include a network-heavy traffic data. The excluded resources may be included in an excluded addresses list or table, which is configured as part of split tunneling configuration. In some embodiments, the split tunneling configuration is implemented by an admin.

The method 1500 may be implemented as part of another method such as block 1310 of the method 1300. The method 1500 may begin at block 1502 in which, a received DNS response may be parsed. The received DNS response may be parsed using a virtual adapter. The received DNS response may be parsed to identify a record type indicating that the excluded resources includes both IPv4 and IPv6 addresses. For instance, the record type may include an AAAA (or quad A) record that is indicate of both an IPv4 and IPv6 addresses. The IPv6 and the IPv4 addresses may include addresses on the excluded address list.

At block 1504, the identified DNS response is replaced with a dummy NODATA AAAA DNS response. For instance, in response to the received DNS response having the AAAA record, the identified DNS response is replaced with the dummy NODATA AAAA DNS response.

At block 1506, the dummy NODATA AAAA DNS response is injected to the virtual adapter. The injection of the dummy NODATA AAAA DNS response results in the DNS client having only an IPv4 address for the excluded resource. The excluded IPv4 address is routed via a physical adapter and the excluded resources are accessed via the physical adapter.

For instance, FIGS. 3-5 depict a FQDN table 300, a configuration table 400, and a behavior table 500. In the FQDN table 300 of FIG. 3, two FQDN are displayed as well as IPv4 and IPv6 addresses for each of FQDN. The two FQDN include ‘www.externalApp.com’ and ‘www.internalApp.com’. The IP addresses for www.externalApp.com and www.internalApp.com include IPv4 and IPv6 addresses, which are also displayed in the FQDN table 900.

The configuration table 400 of FIG. 4 is related to the example FQDN table 300 of FIG. 3. The configuration table 400 designates an excluded IPv4 address as “1.2.3.4,” an excluded IPv6 address ‘2001::1234,’ and further designates the tunnel configuration as a single stack IPv6 only.

The behavior table 500 of FIG. 5 indicates where (e.g., the virtual adapter or physical adapter) the example FQDNs are accessed. For an IPv4 only endpoint accessing www.externalapp.com the DNS response includes 1.2.3.4 and 2001::1234. The endpoint is IPv4 only and the IP addresses are excluded in the configuration table 400. Accordingly, the final DNS response sent to the application is 1.2.3.4 (e.g., the IPv4 address). Because this is an IPv4 address and it is excluded, www.externalapp.com is accessed via the physical adapter. Similarly, when the dual stack endpoint accesses www.externalapp.com, the DNS response includes 1.2.3.4 and 2001::1234, which are excluded in the configuration table 400 in FIG. 4. The IPv4 and IPv6 are both included, which would accompany an AAAA record.

In some embodiments in which the FQDN table 300, the configuration table 400, and the behavior table 500 are implemented, the endpoint (e.g., the endpoint 106) includes a dual stack configuration. A physical adapter (e.g., 113) includes IPv4 and IPv6 capabilities. A client (e.g., the client 110) does not block the AAAA record and application is able to access the www.Externalapp.com via the IPv6 of the physical adapter.

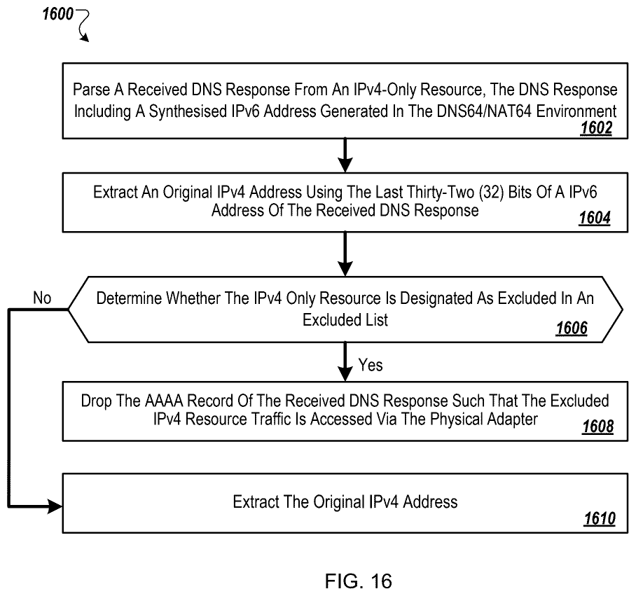

FIG. 16 is a block diagram of an example method 1600 of forcing access to excluded IPv4-only resources via the physical adapter in DNS64/NAT64 environments according to some embodiments of the present disclosure. The method 1600 may begin at block 1602 in which a received DNS response from an IPv4-only resource is parsed. The received DNS response includes a synthesized IPv6 address generated in the DNS64/NAT64 environment. At block 1604, an original IPv4 address is extracted from the received DNS response. In some embodiments, the original IPv4 address may be extracted based on an IPv6 address of the received DNS response. For instance, the original IPv4 address may be extracted using the last thirty-two (32) bits of the one-hundred and twenty-eight (128)-bit synthesized IPv6 address. At block 1606, it may be determined whether the IPv4 only resource is designated as excluded in an excluded list. In response to the IPv4-only resource designated as excluded (“YES” at block 1606), the method 1600 may proceed to block 1608. In response to the IPv4-only resource not designated as excluded (“NO” at block 1606), the method 1600 may proceed to block 1610. At block 1608, an AAAA record of the received DNS response may be dropped such that the excluded IPv4 resource traffic is accessed via the physical adapter. At block 1610, the synthesized IP address is routed to the virtual adapter.

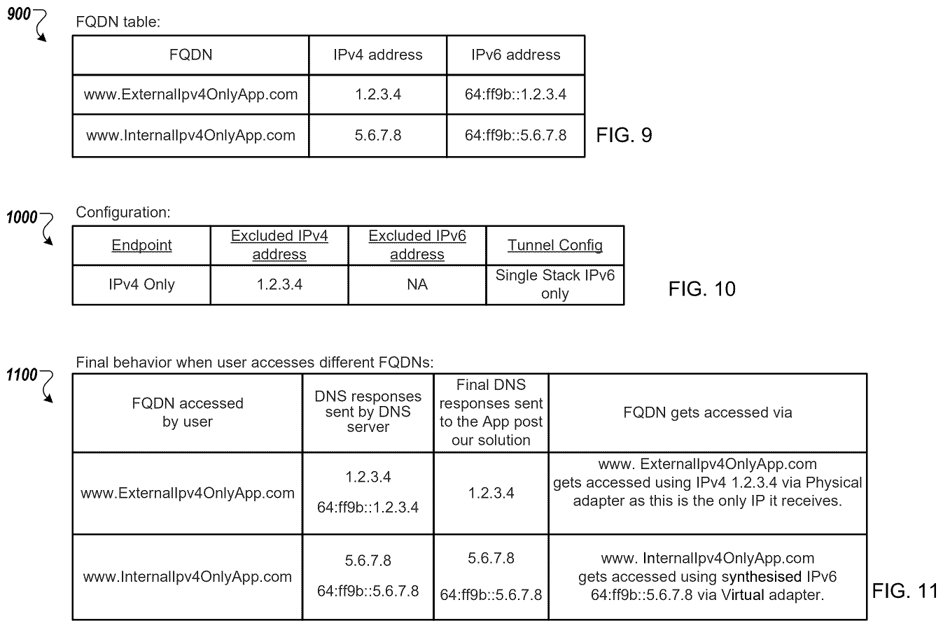

For instance, FIGS. 9-11 depicts a FQDN table 900, a configuration table 1000, and a behavior table 1100. In the FQDN table 900, two FQDN are displayed as well as IPv4 and IPv6addresses for each of FQDN. The two FQDN include ‘www.externalIpv4OnlyApp.com’ and ‘www.internalIpv4OnlyApp.com’ which may both be IPv4-only resources deployed in a DNS64/NAT64 environment. Accordingly, the IP addresses for www.externalIpv4OnlyApp.com and www.internalIpv4OnlyApp.com may include synthesized IP addresses (formatted according to the DNS64/NAT64 protocol(s)) and AAAA record. Example IPv4 and IPv6 addresses are included in the FQDN table 900 for each of the example FQDNs www.externalIpv4OnlyApp.com and www.internalIpv4OnlyApp.com.

The configuration table 1000 of FIG. 10 is related to the example FQDN table 900 of FIG. 9. The configuration table 1000 designates an excluded IPv4 address as “1.2.3.4” and further designates the tunnel configuration as a single stack IPv6 only.

The behavior table 1100 of FIG. 11 indicates where (e.g., the virtual adapter or the physical adapter) the example FQDN are accessed. For both of the FQDNs, the DNS responses sent by the DNS server include a synthesized IP address that is derived from the IPv4 address of the resource. For example, a first DNS response for a first FQDN, www.externalIpv4OnlyApp.com, includes a first synthesized IP address including 1.2.3.4. The second DNS response for a second FQDN, www.internalIpv4OnlyApp.com, includes a second synthesized IP address including 5.6.7.8. The first DNS response includes an excluded IPv4 address according to the configuration table 1000. Accordingly, the original IPv4 address (namely 1.2.3.4) is extracted from the first synthesized IP address of the first DNS response sent by the DNS server. The original, extracted IPv4 address is then sent to the application. Because the first FQDN, www.externalIpv4OnlyApp.com, is accessed the original, extracted IPv4 address. Because the virtual adapter is IPv6-only, the original, extracted IPv4 is accessed using the physical adapter.

In contrast, the second DNS response for the second FQDN, www.internalIpv4OnlyApp.com, is not designated as an excluded IPv4 address according to the configuration table 1000 of FIG. 10. Accordingly, the original IPv4 address is not extracted from the second DNS response and instead the entire synthesized IPv6 address is sent to the application. Additionally, the second FQDN is accessed using the synthesized IPv6 via the virtual adapter.

Although illustrated as discrete blocks, one or more blocks in FIGS. 13-16 may be divided into additional blocks, combined into fewer blocks, or eliminated, depending on the desired implementation. One or more of the methods described in the present disclosure may be performed in a suitable operating environment such as the operating environment 100. The methods 1300, 1400, 1500, and 1600 may be performed by the client 110 of the endpoint 106 or another computing device (e.g., 1200 of FIG. 12). In some embodiments, the endpoint 106 or another computing system may include or may be communicatively coupled to a non-transitory computer-readable medium (e.g., the memory 1212 of FIG. 12) having stored thereon programming code or instructions that are executable by one or more processors (such as the processor 1210 of FIG. 12) to cause a computing system or the endpoint 106 to perform or control performance of the methods. Additionally or alternatively, the endpoint 106 or another computing device may include the processor 1210 described elsewhere in this disclosure that is configured to execute computer instructions to cause the endpoint 106 or another computing systems to perform or control performance of the methods.

Further, modifications, additions, or omissions may be made to the methods without departing from the scope of the present disclosure. For example, the operations of methods may be implemented in differing orders. Furthermore, the outlined operations and actions are only provided as examples, and some of the operations and actions may be optional, combined into fewer operations and actions, or expanded into additional operations and actions without detracting from the disclosed embodiments.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe embodiments of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.” However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present inventions have been described in detail, it should be understood that the various changes, substitutions, and alterations could be made hereto without departing from the scope of the invention.

What is claimed is:

1. A method of data traffic management in networks having mixed internet protocol (IP) address standards, the method comprising:
creating a virtual adapter at an endpoint, wherein the virtual adapter is configured for split tunneling of at least a portion of data traffic via a virtual private network (VPN) connection with an internet protocol version 6 (IPv6) only internal network including at least one internal resource, and the endpoint is communicatively connected to at least one external resource;
assigning only an IPv6 address to the virtual adapter, such that the virtual adapter does not have an internet protocol version 4 (IPv4) address or an automatic private IP address (APIPA) IPv4 address;
blocking domain name server (DNS) traffic in response to a source internet protocol (IP) address of the DNS traffic is a physical adapter IP address of a physical adapter;
accessing excluded resources configured via IPv4 and IPv6 split tunneling policies via the physical adapter;
forcing access to excluded IPv4 only resources via the physical adapter in DNS64/NAT64 environments; and
forcing applications that prefer IPv4 over IPv6 to use IPv6 while accessing dual stack resources.

2. The method of claim 1, wherein the virtual adapter is a virtual network adapter implemented without hardware and operates as a physical network adapter.

3. The method of claim 1, wherein the endpoint has a IPv4-only, a IPv6-only, or a dual stack network configuration.

4. The method of claim 1, wherein the accessing the excluded resources configured for IPv4 and IPv6 split tunneling policies includes:
parsing a received DNS response to identify a record type indicating that the excluded resources includes both IPv4 and IPv6 addresses, wherein the record type includes an AAAA record; and
responsive to identification of the record type, replacing the received DNS responses identified with the record type with a dummy NODATA AAAA DNS response; and
injecting the dummy NODATA AAAA DNS response to the virtual adapter, wherein the injection of the dummy NODATA AAAA DNS response results in only having an IPv4 address for the excluded resource.

5. The method of claim 4, wherein:
the excluded resources include a network-heavy traffic data; and
the IPv6 and the IPv4 addresses are addresses of multiple addresses of an excluded address list.

6. The method of claim 5, wherein:
the excluded addresses list is configured as part of split tunneling configuration; and
the split tunneling configuration is implemented by an admin.

7. The method of claim 1, wherein the blocking traffic based on source IP address includes:
receiving, at a firewall, outgoing internet protocol (IP) packet;
verifying that source IP address of the IP packet matches a virtual adapter IP address associated with a virtual adapter of a VPN client;
responsive to a determination that the source IP address matches the IP address associated with the virtual adapter, passing the IP packet through the firewall;
responsive to a determination that the source IP address does not match the IP address associated with the virtual adapter:
determining whether a destination port of the IP packet is port 53;
in response to determining that the destination port is the port 53, dropping the IP packet at the firewall; and
in response to determining that the destination port is not the port 53, passing the IP packet through the firewall.

8. The method of claim 1, wherein forcing applications that prefer IPv4 over IPv6 to use IPv6 while accessing dual stack resources includes:
receiving DNS responses including both IPv4 and IPv6 addresses from one resource; and
filtering the DNS response including the IPv4 address such that only the IPv6 DNS response is received at the virtual adapter.

9. The method of claim 1, wherein the forcing access to excluded IPv4 only resources via the physical adapter in DNS64/NAT64 environments includes:
parsing a received DNS response from an IPv4-only resource, the DNS response including a synthesized IPv6 address generated in the DNS64/NAT64 environment;
extracting an original IPv4 address using the last thirty-two (32) bits of a IPv6 address of the received DNS response;
determining whether the IPv4 only resource is configured as excluded in an excluded list;
responsive to the IPv4 only resource being excluded, dropping an AAAA record of the received DNS response such that excluded IPv4 resource traffic is accessed via the physical adapter; and
responsive to the IPv4 only resource not being excluded, routing the synthesized IP address to the virtual adapter.

10. The method of claim 9, wherein the original IPv4 address is extracted using the last 32 bits of a 128-bit synthesized IPv6 address.

11. Non-transitory computer-readable media having encoded therein programming code executable by one or more processors to perform or control performance of operations of any of data traffic management in networks having mixed internet protocol (IP) address standards, the operations comprising:
creating a virtual adapter at an endpoint, wherein the virtual adapter is configured for split tunneling of at least a portion of data traffic via a virtual private network (VPN) connection with an internet protocol version 6 (IPv6) only internal network including at least one internal resource, and the endpoint is communicatively connected to at least one external resource;
assigning only an IPv6 address to the virtual adapter, such that the virtual adapter does not have an internet protocol version 4 (IPv4) address or an automatic private IP address (APIPA) IPv4 address;
blocking domain name server (DNS) traffic in response to a source internet protocol (IP) address of the DNS traffic is a physical adapter IP address of a physical adapter;
accessing excluded resources configured via IPv4 and IPv6 split tunneling policies via the physical adapter;
forcing access to excluded IPv4 only resources via the physical adapter in DNS64/NAT64 environments; and
forcing applications that prefer IPv4 over IPv6 to use IPv6 while accessing dual stack resources.

12. The non-transitory computer-readable media of claim 11, wherein the virtual adapter is a virtual network adapter implemented without hardware and operates as a physical network adapter.

13. The non-transitory computer-readable media of claim 11, wherein the endpoint has a IPv4-only, a IPv6-only, or a dual stack network configuration.

14. The non-transitory computer-readable media of claim 11, wherein the accessing the excluded resources configured for IPv4 and IPv6 split tunneling policies includes:
parsing a received DNS response to identify a record type indicating that the excluded resources includes both IPv4 and IPv6 addresses, wherein the record type includes an AAAA record; and
responsive to identification of the record type, replacing the received DNS responses identified with the record type with a dummy NODATA AAAA DNS response; and
injecting the dummy NODATA AAAA DNS response to the virtual adapter, wherein the injection of the dummy NODATA AAAA DNS response results in only having an IPv4 address for the excluded resource.

15. The non-transitory computer-readable media of claim 14, wherein:
the excluded resources include a network-heavy traffic data; and
the IPv6 and the IPv4 addresses are addresses of multiple addresses of an excluded address list.

16. The non-transitory computer-readable media of claim 15, wherein:
the excluded addresses list is configured as part of split tunneling configuration; and
the split tunneling configuration is implemented by an admin.

17. The non-transitory computer-readable media of claim 11, wherein the blocking traffic based on source IP address includes:
receiving, at a firewall, outgoing internet protocol (IP) packet;
verifying that source IP address of the IP packet matches a virtual adapter IP address associated with a virtual adapter of a VPN client;
responsive to a determination that the source IP address matches the IP address associated with the virtual adapter, passing the IP packet through the firewall;
responsive to a determination that the source IP address does not match the IP address associated with the virtual adapter:
determining whether a destination port of the IP packet is port 53;
in response to determining that the destination port is the port 53, dropping the IP packet at the firewall; and
in response to determining that the destination port is not the port 53, passing the IP packet through the firewall.

18. The non-transitory computer-readable media of claim 11, wherein forcing applications that prefer IPv4 over IPv6 to use IPv6 while accessing dual stack resources includes:
receiving DNS response including both IPv4 over IPv6 addresses from one resource; and
filtering the DNS response including the IPv4 address such that only the IPv6 DNS response is received at the virtual adapter.

19. The non-transitory computer-readable media of claim 11, wherein the forcing access to excluded IPv4 only resources via the physical adapter in DNS64/NAT64 environments includes:
parsing a received DNS response from an IPv4-only resource, the DNS response including a synthesized IPv6 address generated in the DNS64/NAT64 environment;
extracting an original IPv4 address using the last thirty-two (32) bits of a IPv6 address of the received DNS response;
determining whether the IPv4 only resource is configured as excluded in an excluded list;
responsive to the IPv4 only resource being excluded, dropping an AAAA record of the received DNS response such that excluded IPv4 resource traffic is accessed via the physical adapter; and
responsive to the IPv4 only resource not being excluded, routing the synthesized IP address to the virtual adapter.

20. The non-transitory computer-readable media of claim 19, wherein the original IPv4 address is extracted using the last 32 bits of a 128-bit synthesized IPv6 address.
